(19) United States
(12) Patent Application Publication
(10) Pub. No.: US 2014/0257151 A1
(43) Pub. Date: Sep. 11, 2014

(54) HIGH FREQUENCY CHEST WALL OSCILLATION (HFCWO) DATA CONNECTIVITY SYSTEMS AND METHODS

(71) Applicant: Hill-Rom Services Pte Ltd., Singapore (SG)

(72) Inventors: Shadakshari D. Chikkanaravangala, Singapore (SG); Chun-Piaw NG, Singapore (SG)

(73) Assignee: Hill-Rom Services Pte Ltd., Singapore (SG)

(21) Appl. No.: 14/196,173

(22) Filed: Mar. 4, 2014

Related U.S. Application Data
(60) Provisional application No. 61/773,856, filed on Mar. 7, 2013.

(51) Int. Cl. A61H 1/00

(52) U.S. Cl. CPC A61H 1/008
USPC 601/93

(57) ABSTRACT

Systems and methods for data connectivity of High Frequency Chest Wall Oscillation (HFCWO) devices are disclosed herein. Data is transferred from a High Frequency Chest Wall Oscillation (HFCWO) device to a server via a cellular connection. This data is then used for various purposes including providing information about High Frequency Chest Wall Oscillation (HFCWO) therapy, service related information for maintenance, therapy compliance monitoring, billing including insurance claims. Data is also used to update an Electronic Medical Records (EMR) system.

### CROSS-REFERENCE TO RELATED APPLICATIONS

The present application claims the benefit, under 35 U.S.C. §119(e), of U.S. Provisional Application No. 61/773,856, which was filed Mar. 7, 2013, and which is hereby incorporated by reference herein in its entirety.

### BACKGROUND

Control and data connectivity of High Frequency Chest Wall Oscillation (HFCWO) systems is an area of continued interest. While several system and methods exist for control and data connectivity of High Frequency Chest Wall Oscillation (HFCWO) systems, a need exists for development in this area.

### BRIEF SUMMARY

The present disclosure includes one or more of the features recited in the appended claims and/or the following features which, alone or in any combination, may comprise patentable subject matter.

One embodiment of a data connectivity system comprises a high frequency chest wall oscillation device controller. A server may be configured to communicate with the high frequency chest wall oscillation device controller by a cellular communication.

One method comprises transmitting data from a high frequency chest wall oscillation device controller to a server via cellular communication. The server may transmit data to an interface device.

### BRIEF DESCRIPTION OF DRAWINGS

The accompanying drawings, incorporated in and forming a part of the specification, illustrate several aspects of the claimed subject matter and, together with the description, serve to explain the principles of the claimed subject matter. In the drawings:

FIG. 1 shows one embodiment of a High Frequency Chest Wall Oscillation (HFCWO) data connectivity system, constructed according to one or more of the principles disclosed herein;

FIG. 2 shows another embodiment of a High Frequency Chest Wall Oscillation (HFCWO) data connectivity system, constructed according to one or more of the principles disclosed herein;

FIG. 3 shows one embodiment of a High Frequency Chest Wall Oscillation (HFCWO) data connectivity system, constructed according to one or more of the principles disclosed herein;

FIG. 4 shows an embodiment of a High Frequency Chest Wall Oscillation (HFCWO) data connectivity system, constructed according to one or more of the principles disclosed herein; and

FIG. 5 shows data flow in one embodiment of a High Frequency Chest Wall Oscillation (HFCWO) data connectivity system, constructed according to one or more of the principles disclosed herein.

### DETAILED DESCRIPTION OF ILLUSTRATIVE EMBODIMENTS

The embodiments of the claimed subject matter and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be briefly mentioned or omitted so as to not unnecessarily obscure the embodiments of the claimed subject matter described. The examples used herein are intended merely to facilitate an understanding of ways in which the claimed subject matter may be practiced and to further enable those of skill in the art to practice the embodiments of the claimed subject matter described herein. Accordingly, the examples and embodiments herein are merely illustrative and should not be construed as limiting the scope of the claimed subject matter, which is defined solely by the appended claims and applicable law. Moreover, it is noted that like reference numerals represent similar parts throughout the several views of the drawings.

It is understood that the subject matter claimed is not limited to the particular methodology, protocols, devices, apparatus, materials, applications, etc., described herein, as these may vary. It is also to be understood that the terminology used herein is used for the purpose of describing particular embodiments only, and is not intended to limit the scope of the claimed subject matter.

Unless defined otherwise, all technical and scientific terms used herein have the same meanings as commonly understood by one of ordinary skill in the art.

The subject matter disclosed herein is generally related to data connectivity of a High Frequency Chest Wall Oscillation (HFCWO) system.

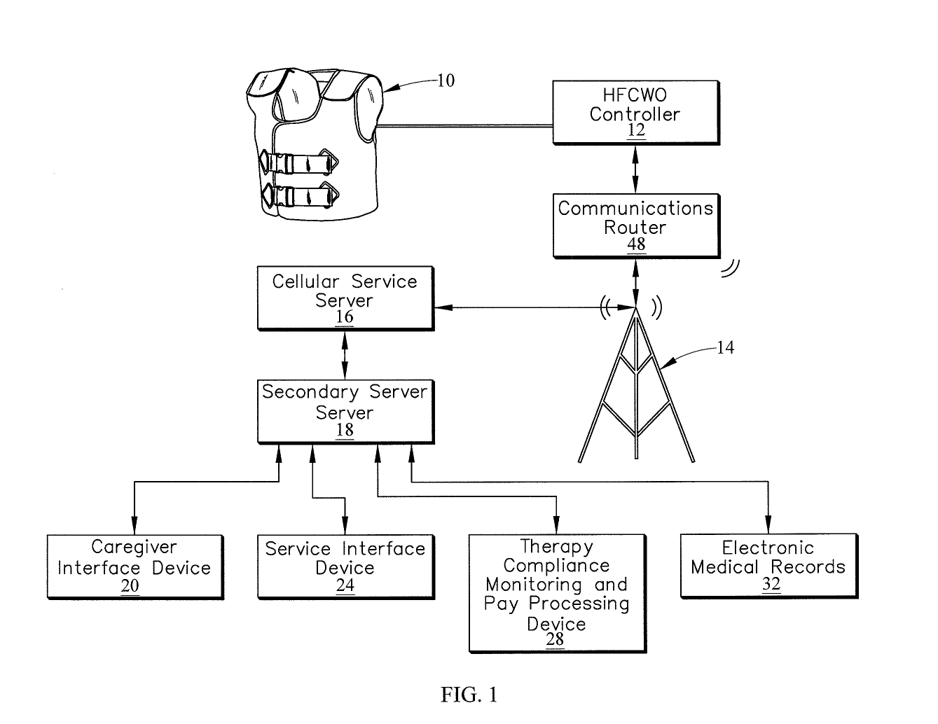

FIG. 1 shows a High Frequency Chest Wall Oscillation (HFCWO) device 10 configured to be controlled by a High Frequency Chest Wall Oscillation (HFCWO) controller 12. In this embodiment, the HFCWO device 10 is a garment based device configured to provide a force on the chest wall of a user to aid in removal of mucus from the airways. In this embodiment, the HFCWO device 10 is a pneumatic device wherein HFCWO controller 12 is configured to control supply of gas to the HFCWO device 10 thereby controlling compressive force on the chest wall of the user. In other embodiments, the HFCWO device 10 may be of any type including but not limited to any combination of mechanical, pneumatic, hydraulic, electrical components to provide chest wall oscillation therapy wherein the HFCWO controller 12 serves to control the HFCWO device 10. Embodiments of High Frequency Chest Wall Oscillation (HFCWO) devices and controllers are found in U.S. Pat. No. 8,052,626 and U.S. Patent Application Publication No. 2012/0035514 both of which are hereby incorporated by reference herein.

The HFCWO controller 12 is configured to communicate with a communications router 48. In this embodiment, the HFCWO controller 12 is configured to communicate with the communications router 48 via a wireless connection, while in another embodiment, the HFCWO controller 12 is configured to communicate with a communications router 48 via a wired connection. In this embodiment, the HFCWO controller 12 is configured to communicate with the communications router 48 using Bluetooth technology, while in other embodiments, the HFCWO controller 12 may communicate with the communications router 48 using any protocol and/or technology including but not limited to ZigBee. In other embodiments, the HFCWO controller 12 may communicate with the communications router 48 using any radio frequency signal.

The communications router 48 is configured to communicate with a cellular service server 16 via a cellular connection in the embodiment shown in FIG. 1. In this embodiment, the communications router 48 is configured to communicate with the cellular service server 16 via a connection through a cellular tower 14. In another embodiment, any number of cellular towers may relay information between the communications router 10 and the cellular service server 16. In another embodiment, the communications router 10 is configured to communicate with the cellular service server 16 via any combination of data transfer between communications satellites and/or cellular towers. Cellular service server 16 is a computer in this embodiment, while in other embodiments, the cellular service server 16 may be any computing device configured to communicate with the communications router 48 via a cellular connection. The cellular service server 16 is configured to transfer at least a portion of data received from the communications router 48 to a secondary server 18. Secondary server 18 is configured to transmit data to a caregiver interface device 20, service interface device 24, therapy compliance monitoring and pay processing device 28 and electronic medical records (EMR) 32, in this embodiment. The caregiver interface device 20 is a computer in this embodiment and is configured to display indications of HFCWO therapy as well as allow a caregiver to control operating parameters of the HCFWO therapy which are then transmitted to the HFCWO controller 12 via the secondary server 18, cellular service server 16 and communications router 48. Data transmitted from the secondary server 18 to the service interface device 24, which is a computer in this embodiment, allows a service technician to be alerted of need for scheduled and/or unscheduled maintenance. The therapy compliance monitoring and pay processing device 28 is a computer in this embodiment and is configured to determine compliance of HFCWO therapy relative to a prescribed routine. Information regarding adherence of a prescribed protocol and/or use of HFCWO device is used for determination of insurance reimbursements and/or pay processing for services rendered in this embodiment. Data from the secondary server 18 is also logged in an electronic medical record (EMR) 32 in this embodiment.

While the caregiver interface device 20, service interface device 24, therapy compliance monitoring and pay processing device 28 and electronic medical record (EMR) 32 are cited as computers in the embodiment shown in FIG. 1, in other embodiments, they may be any combination of a display and any type of computing device including but not limited to PDAs, phones, tablets, smart watches and smart glasses.

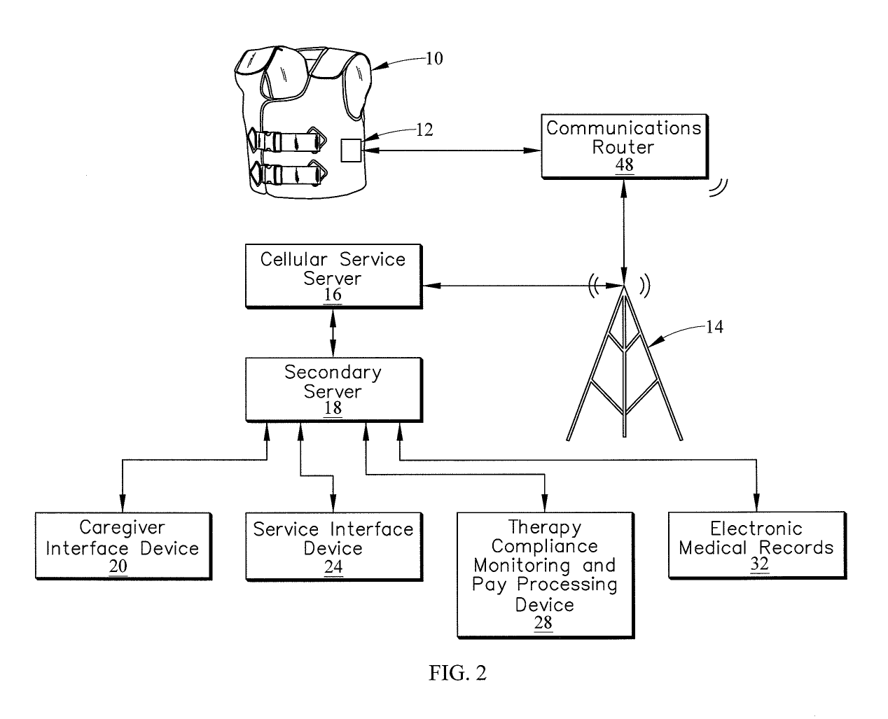

FIG. 2 shows another embodiment of data connectivity of a High Frequency Chest Wall Oscillation (HFCWO) system. In the embodiment shown in FIG. 2, the HFCWO controller 12 is mounted on to the HFCWO device 10. The HFCWO controller 12 is configured to communicate with the communications router 48 wirelessly in one embodiment. The communications router 48 is configured to communicate with a cellular service server 16 via a cellular connection in this embodiment via cellular tower 14. The cellular service server 16 is configured to communicate with a secondary server 18 wirelessly in this embodiment while in other embodiments the cellular service server 16 is configured to communicate with a secondary server 18 through a wired connection. Secondary server 18 is configured to transmit data to a caregiver interface device 20, service interface device 24, therapy compliance monitoring and pay processing device 28 and electronic medical records (EMR) 32 in this embodiment wirelessly in this embodiment, while in other embodiments, one or more of the aforementioned data connections may be wired.

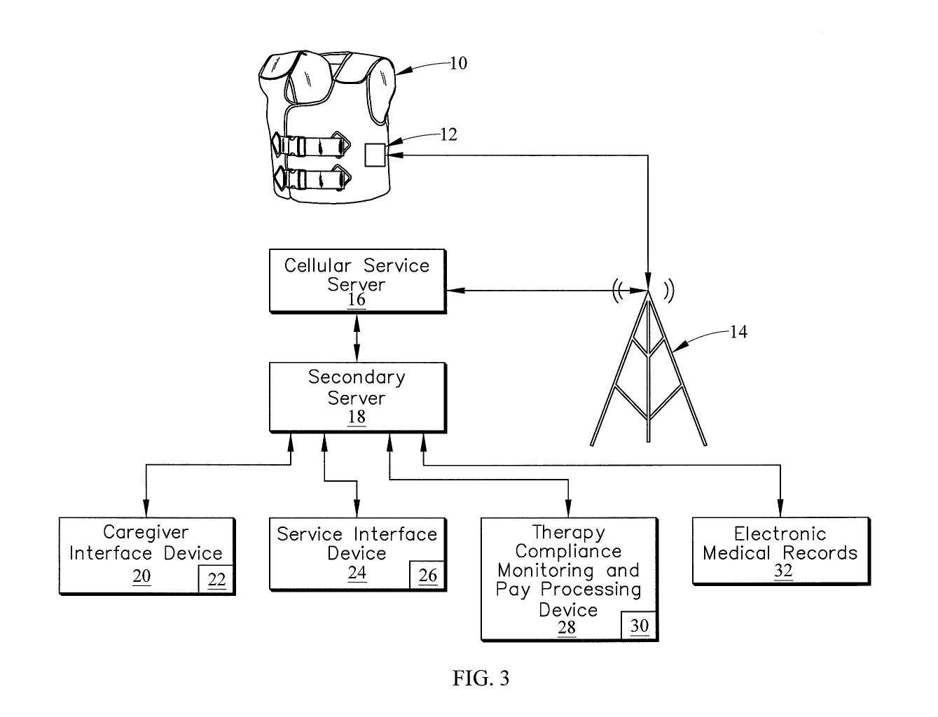

FIG. 3 shows one embodiment of a High Frequency Chest Wall Oscillation (HFCWO) system. In the embodiment shown in FIG. 3, the HFCWO controller 12 is mounted on to the HFCWO device 10. In the embodiment shown in FIG. 3, the HFCWO controller 12 includes hardware and/or software configured to communicate with the cellular service server 16 via a cellular connection, in this embodiment by way of cellular tower 14. In the embodiment shown in FIG. 3, the caregiver interface device 20 comprises a caregiver interface display 22 to display information to a caregiver or user. As shown, the service interface device 24 comprises a service interface display 26 to display information related to scheduled and/or unscheduled maintenance. The therapy compliance monitoring and pay processing device 28 comprises a therapy compliance monitoring display 30.

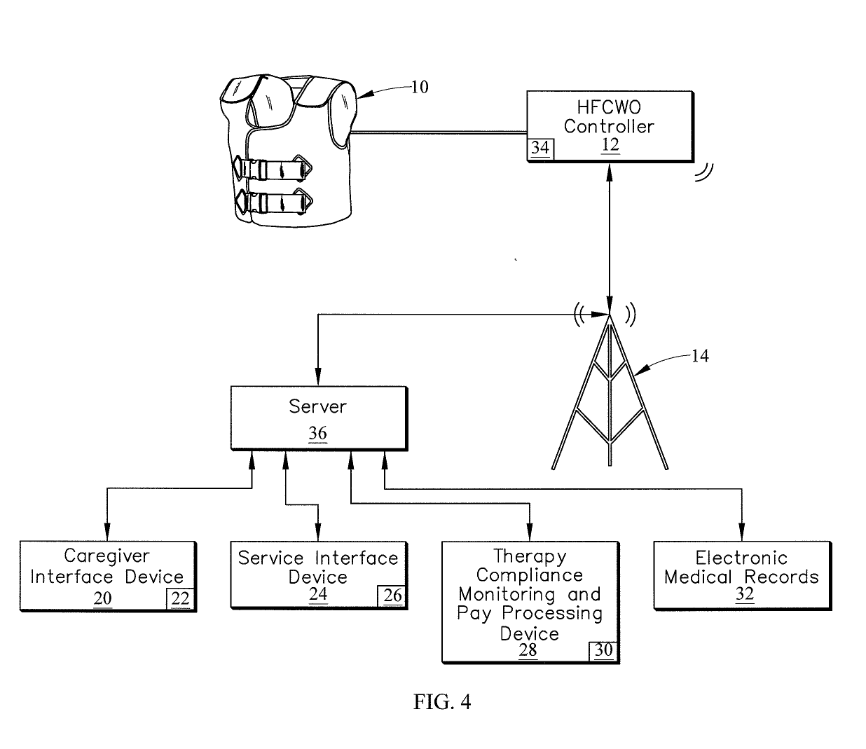

FIG. 4 shows another embodiment of a High Frequency Chest Wall Oscillation (HFCWO) data connectivity system. As shown in FIG. 4, a HFCWO controller 12 comprising a HFCWO controller display 34 is configured to control a HFCWO device 10. The HFCWO controller 12 includes hardware and/or software configured to communicate with a server 36 via a cellular connection, in this embodiment by way of cellular tower 14. In the embodiment shown in FIG. 4, the server 36 is configured to communicate with the caregiver interface device 20, service interface device 24, therapy compliance monitoring and pay processing device 28 and electronic medical records (EMR) 32. In the embodiment shown in FIG. 4, the server 36 is configured to perform one or more functions of the cellular service server 16 and the secondary server 18.

While embodiments shown in FIGS. 1-4 describe caregiver interface device 20, service interface device 24, therapy compliance monitoring and pay processing device 28 and electronic medical records (EMR) 32 as physically separate devices, in other embodiments, any one or combination of functions performed by these devices may be performed by one or more devices. In one embodiment, a single device performs all the functions of caregiver interface device 20, service interface device 24, therapy compliance monitoring and pay processing device 28.

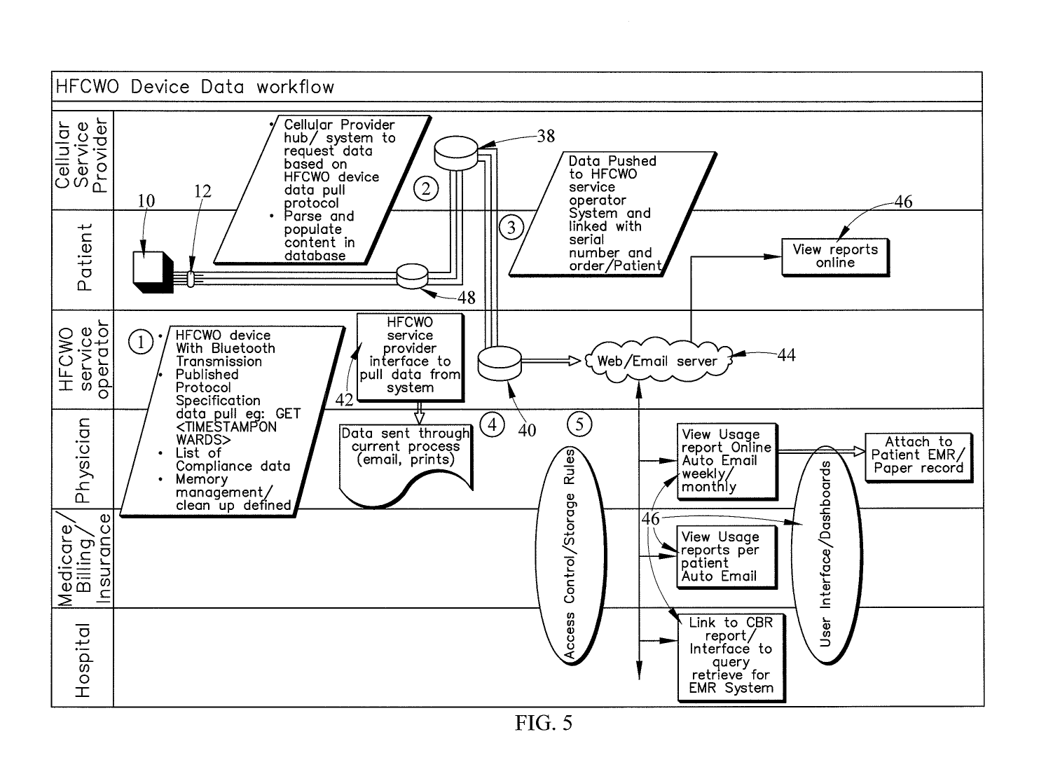

FIG. 5 shows data flow in one embodiment of a High Frequency Chest Wall Oscillation (HFCWO) system. The HFCWO device 10 is configured to be controlled by a HFCWO controller 12. The HFCWO controller 12 is configured to communicate with a communications router via a wireless connection, in this embodiment using Bluetooth technology. The HFCWO controller 12 stores information related to protocol for data transmission, in this embodiment information related to the time interval when data is to be transmitted. In this embodiment the HFCWO controller 12 is configured to transmit data related to compliance with prescribed therapy, while in another embodiment, the HFCWO controller 12 is configured to store this data on a resident memory device. In this embodiment, the HFCWO controller 12 also stores rules related protocols for memory management and/or data purging of resident memory device.

In the embodiment shown in FIG. 5, the cellular service provider system 38 communicates with and requests databased on the HFCWO controller 12 data pull protocol via communications router 48. In this embodiment, the HFCWO controller 12 communicates with the communications router 48 via Bluetooth technology and the communications router 48 communicates with the cellular service provider server 38 via a cellular connection. The cellular service provider server 38 parses and populates content received from the HFCWO controller 12 into its database. The cellular service provider server 38 is configured to push data to a secondary server 40 in this embodiment. The cellular service provider server 38 and the secondary server 40 are configured to use the serial number of the HFCWO device 10 and/or a HFCWO controller 12 identifier and/or a patent identifier to transmit data from the cellular service provider server 38 to the appropriate database of the secondary server 40. A HFCWO service provider interface 42 is configured to allow extraction of data from the secondary server 40 in this embodiment which is then accessible to be transmitted using any means including but not limited to e-mails, printing etc. In this embodiment, the secondary server is also configured to communicate data to a web server 44. Web server 44 is configured to provide data to one or more interface devices 46. In this embodiment, the web server 44 is configured to make data available for viewing online by webhosting data and reports. The web server 44 is also configured to provide information at a periodic time interval and, in one embodiment, information specific to a patient, to various interface devices 46 based on storage and/or access control rules. In one embodiment data is supplied to an electronic medical record (EMR) system.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

The disclosures of any references and publications cited above are expressly incorporated by reference in their entireties to the same extent as if each were incorporated by reference individually.

1. A data connectivity system comprising:
a high frequency chest wall oscillation device controller; and
a server configured to communicate with said high frequency chest wall oscillation device controller by cellular communication.

2. The system of claim 1, further comprising a communications router configured to communicate with said high frequency chest wall oscillation device controller, said communications router configured to communicate with said server by cellular communication.

3. The system of claim 2, wherein said high frequency chest wall oscillation device controller is configured to communicate with said communications router wirelessly by Bluetooth technology.

4. The system of claim 1, wherein said server is configured to request data from said high frequency chest wall oscillation device controller based on a data pull protocol.

5. The system of claim 1, further comprising a secondary server configured to communicate with said server.

6. The system of claim 5, wherein said secondary server is configured to communicate with said server based on a serial number of said high frequency chest wall oscillation device controller.

7. The system of claim 5, wherein said secondary server is configured to communicate with said server based on an identity of a user.

8. The system of claim 5, further comprising an interface device and wherein said secondary server is configured to communicate data received from said high frequency chest wall oscillation device controller to said interface device.

9. The system of claim 8, further comprising a webserver and wherein said secondary server is configured to communicate data received from said high frequency chest wall oscillation device controller to said interface device via said web server.

10. A method comprising:
transmitting data from a high frequency chest wall oscillation device controller to a server via cellular communication; and
transmitting data from said server to an interface device.

11. The method of claim 10, further comprising the operation of transmitting data from a high frequency chest wall oscillation device controller to a communications router which is configured to communicate with a server via cellular communication.

12. The method of claim 11, wherein said high frequency chest wall oscillation device controller is configured to communicate with said communications router wirelessly via a Bluetooth connection.

13. The method of claim 10, wherein said server in configured to request data from said high frequency chest wall oscillation device controller based upon a data pull protocol.

14. The method of claim 10, wherein said server is configured to populate a database with at least a portion of data received from said high frequency chest wall oscillation device controller.

15. The method of claim 10, wherein said high frequency chest wall oscillation device controller comprises a memory configured to store compliance data.

16. The method of claim 10, wherein said high frequency chest wall oscillation device controller comprises a memory configured to store usage data.

17. The method of claim 10, wherein said server is configured to transmit at least a portion of data received from said high frequency chest wall oscillation device controller to a billing interface device.

18. The method of claim 10, wherein said server is configured to transmit at least a portion of data received from said high frequency chest wall oscillation device controller to an electronic medical record database.

19. The method of claim 10, wherein said server is configured to transmit at least a portion of data received from said high frequency chest wall oscillation device controller to a caregiver interface device.

20. The method of claim 10, wherein said server is configured to transmit at least a portion of data received from said high frequency chest wall oscillation device controller to a secondary server.

21. The method of claim 20, wherein said server is configured to transmit at least a portion of data received from said high frequency chest wall oscillation device controller to a secondary server based on an identifier of at least one of said high frequency chest wall oscillation device and said high frequency chest wall oscillation device controller.

22. The method of claim 20, wherein said server is configured to transmit at least a portion of data received from said high frequency chest wall oscillation device controller to a secondary server based on a patient identifier.

23. The method of claim 20, wherein said secondary server is configured to transmit at least a portion of data received from said server to a billing interface device.

24. The method of claim 20, wherein said secondary server is configured to transmit at least a portion of data received from said server to an electronic medical record database.

25. The method of claim 20, wherein said secondary server is configured to transmit at least a portion of data received from said server to a caregiver interface device.
